(19) United States
(12) Patent Application Publication
(10) Pub. No.: US 2025/0259170 A1
(43) Pub. Date: Aug. 14, 2025

(54) TRANSACTION PROCESSOR TESTING METHOD AND SYSTEM

(71) Applicant: Visa International Service Association, San Francisco, CA (US)

(72) Inventors: Mehmet Turkuzan, Irvine, CA (US); Jayminsinh Madansinh Vihol, Union City, CA (US)

(73) Assignee: Visa International Service Association, San Francisco, CA (US)

(21) Appl. No.: 18/438,505

(22) Filed: Feb. 11, 2024

(51) Int. Cl. G06Q 20/40

(52) U.S. Cl. CPC G06Q 20/401; G06Q 20/405

(57) ABSTRACT

A transaction-processor tester system for examining a transaction processor is disclosed. The system includes a rule generator, a storage medium, a rule selector, a transaction generator, a payload parser, and a payload validator. The storage medium is to receive and store random transaction rules. The rule selector is to receive an input indicative of at least one selected rule type, and retrieve a subset of the random transaction rules. The transaction generator is to generate simulated transactions based on predefined transaction map and transaction-parameter conditions, check the simulated transactions against the subset of rules, and output expected values based on the simulated transactions that are in accordance with the subset of rules. The payload includes an output of the transaction processor from processing the subset of the simulated transactions. The output of the transaction processor includes actual values associated with processing the subset of the simulated transactions.

### TECHNICAL FIELD

The following disclosure relates generally to methods and system for evaluating transaction processors.

### SUMMARY

In various embodiments, a transaction-processor tester system for examining a transaction processor is disclosed. The transaction-processor tester system includes a rule generator to create random transaction rules based on predefined transaction parameters and predefined limits associated with the predefined transaction parameters, a storage medium to communicate with the rule generator, a rule selector in communication with the storage medium, a transaction generator, a payload parser to receive a payload from the transaction processor, and a payload validator to output a test result for the transaction processor based on the actual values and expected values. The storage medium is to receive and store the random transaction rules. The rule selector is to receive an input indicative of at least one selected rule type, and retrieve a subset of the random transaction rules based on the input. The transaction generator is to generate simulated transactions based on a predefined transaction map and predefined transaction-parameter conditions, check the simulated transactions against the subset of the random transaction rules, and output expected values based on the simulated transactions that are in accordance with the subset of the random transaction rules. The payload includes an output of the transaction processor from processing the subset of the simulated transactions. The output of the transaction processor includes actual values associated with processing the subset of the simulated transactions.

In various embodiments, a method for testing a transaction processor is disclosed. The method includes generating random transaction rules based on predefined transaction parameters and predefined limits associated with the predefined transaction parameters, determining a subset of the random transaction rules corresponding to at least one selected rule type, generating simulated transactions based on a predefined transaction map and predefined transaction-parameter conditions, determining expected results associated with processing of the simulated transactions based on the subset of the random transaction rules, determining actual results based on an output of the transaction processor resulting from an input of the simulated transactions and the subset of the random transaction rules, and determining an operational state of the transaction processor based on the expected results and actual results.

In various embodiments, a transaction-processor tester system for examining a transaction processor is disclosed. The transaction-processor tester system includes a rule generator to create random transaction rules based on predefined transaction parameters and predefined limits associated with the predefined transaction parameters, a rule selector, a transaction generator, a payload parser, and a payload validator to output a test result for the transaction processor based on the actual results and expected results. The rule selector is to receive an input indicative of at least one selected rule type, and retrieve a subset of the random transaction rules based on the input. The transaction generator is to generate simulated transactions based on a predefined transaction map and predefined transaction-parameter conditions, and determine expected results associated with processing of the simulated transactions based on the subset of the random transaction rules. The payload parser is to receive a payload from the transaction processor, and determine actual results based on the output of the transaction processor. The payload includes an output of the transaction processor from processing the subset of the simulated transactions.

### BRIEF DESCRIPTION OF THE DRAWINGS

In the description, for purposes of explanation and not limitation, specific details are set forth, such as particular aspects, procedures, techniques, etc. to provide a thorough understanding of the present technology. However, it will be apparent to one skilled in the art that the present technology may be practiced in other aspects that depart from these specific details.

The accompanying drawings, where like reference numerals refer to identical or functionally similar elements throughout the separate views, together with the detailed description below, are incorporated in and form part of the specification, and serve to further illustrate aspects of concepts that include the claimed disclosure and explain various principles and advantages of those aspects.

The systems and methods disclosed herein have been represented where appropriate by conventional symbols in the drawings, showing only those specific details that are pertinent to understanding the various aspects of the present disclosure so as not to obscure the disclosure with details that will be readily apparent to those of ordinary skill in the art having the benefit of the description herein.

FIG. 1 illustrates a system for testing transaction processors, according to at least one aspect of the present disclosure.

FIG. 2 illustrates a method for testing transaction processors, according to at least one aspect of the present disclosure.

FIG. 3 illustrates an operation of a rule generator of the system of FIG. 1.

FIG. 4 illustrates an operation of a transaction generator of the system of FIG. 1.

FIG. 5 illustrates an operation of a payload parser of the system of FIG. 1

FIG. 6 is a block diagram of a computer apparatus with data processing subsystems or components, according to at least one aspect of the present disclosure.

FIG. 7 is a diagrammatic representation of an example system that includes a host machine within which a set of instructions to perform any one or more of the methodologies discussed herein may be executed, according to at least one aspect of the present disclosure.

### DESCRIPTION

The following disclosure may provide exemplary systems, devices, and methods for conducting a financial transaction and related activities. Although reference may be made to such financial transactions in the examples provided below, aspects are not so limited. That is, the systems, methods, and apparatuses may be utilized for any suitable purpose.

Before discussing specific embodiments, aspects, or examples, some descriptions of terms used herein are provided below.

As used herein, the term “computing device” or “computer device” may refer to one or more electronic devices that are configured to directly or indirectly communicate with or over one or more networks. A computing device may be a mobile device, a desktop computer, and/or the like. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. The computing device may not be a mobile device, such as a desktop computer. Furthermore, the term “computer” may refer to any computing device that includes the necessary components to send, receive, process, and/or output data, and normally includes a display device, a processor, a memory, an input device, a network interface, and/or the like.

A “payment network” may refer to an electronic payment system used to accept, transmit, or process transactions made by payment devices for money, goods, or services. The payment network may transfer information and funds among issuers, acquirers, merchants, and payment device users. One illustrative non-limiting example of a payment network is VisaNet, which is operated by Visa, Inc.

As used herein, the term “server” may include one or more computing devices which can be individual, stand-alone machines located at the same or different locations, may be owned or operated by the same or different entities, and may further be one or more clusters of distributed computers or “virtual” machines housed within a datacenter. It should be understood and appreciated by a person of skill in the art that functions performed by one “server” can be spread across multiple disparate computing devices for various reasons. As used herein, a “server” is intended to refer to all such scenarios and should not be construed or limited to one specific configuration. Further, a server as described herein may, but need not, reside at (or be operated by) a merchant, a payment network, a financial institution, a healthcare provider, a social media provider, a government agency, or agents of any of the aforementioned entities. The term “server” may also refer to or include one or more processors or computers, storage devices, or similar computer arrangements that are operated by or facilitate communication and processing for multiple parties in a network environment, such as the Internet, although it will be appreciated that communication may be facilitated over one or more public or private network environments and that various other arrangements are possible. Further, multiple computers, e.g., servers, or other computerized devices, e.g., point-of-sale devices, directly or indirectly communicating in the network environment may constitute a “system,” such as a merchant's point-of-sale system. Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

A “server computer” may typically be a powerful computer or cluster of computers. For example, the server computer can be a large mainframe, a minicomputer cluster, or a group of servers functioning as a unit. The server computer may be associated with an entity such as a payment processing network, a wallet provider, a merchant, an authentication cloud, an acquirer or an issuer. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers. In some embodiments or aspects, the server computer may provide and/or support payment network cloud service.

As used herein, the term “system” may refer to one or more computing devices or combinations of computing devices (e.g., processors, servers, client devices, software applications, components of such, and/or the like).

A “user” may include an individual. In some embodiments or aspects, a user may be associated with one or more personal accounts and/or mobile devices. The user may also be referred to as a cardholder, account holder, or consumer.

Transaction processors play a critical role in ensuring that financial transactions are processed accurately and efficiently. However, testing transaction processors can be a complex and time-consuming process, often involving manual testing procedures that are prone to errors. This can result in inaccurate processing of financial transactions, which can lead to lost revenue, compliance issues, and reputational damage. Additionally, the increasing volume and complexity of financial transactions render traditional testing methods inadequate to simulate real-world scenarios. In some aspects, the present disclosure includes various methods and systems that provide a more efficient and effective transaction processor testing to help organizations ensure the accuracy and reliability of their financial transactions while improving operational efficiency and reducing costs.

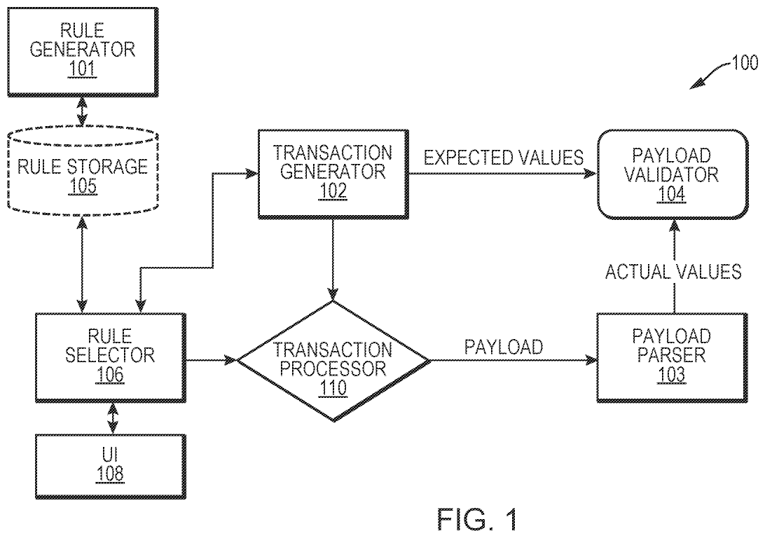

FIG. 1 illustrates a system 100 for testing transaction processors, according to at least one aspect of the present disclosure. The system 100 includes a rule generator 101, a transaction generator 102, a payload parser 103, and a payload validator 104. In some embodiments, as illustrated in FIG. 1, the system 100 can include a rule storage 105, which can include any suitable storage medium. The rule storage 105 may store rules created by the rule generator 101, and can be accessible by the rule generator 101 and the transaction generator 102. In the illustrated embodiment, a transaction processor 110 is coupled to the system 100 for testing. The system 100 can be coupled to multiple transaction processors 110 for testing simultaneously, or can be coupled to one transaction processor 110 at a time for sequential testing.

Further to the above, the system 100 may further include a rule selector 106. The rule selector 106 is to communicate with the storage medium 105 to retrieve rules created by the rule generator 101, as discussed in greater detail below. In some aspects, the rule selector 106 encompasses the rule storage 105, and is to communicate directly with the rule generator 101. In some aspects, the rule generator 101 encompasses the rule storage 105 and the rule selector 106.

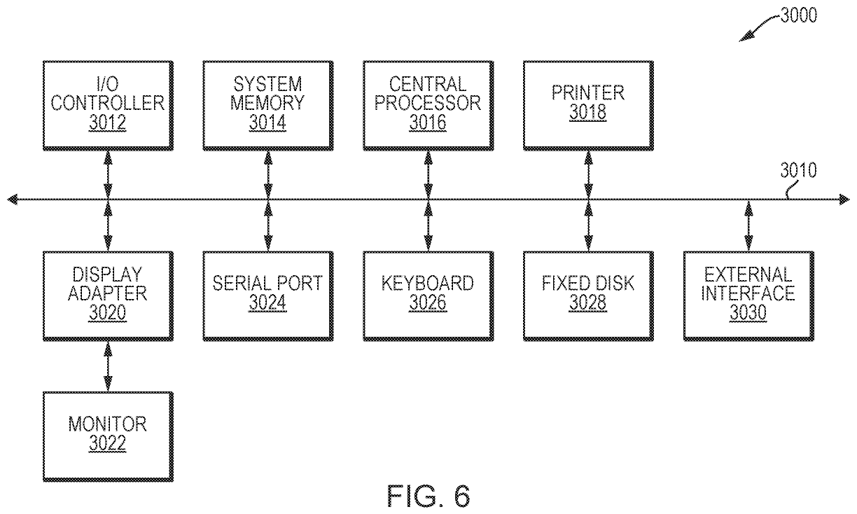

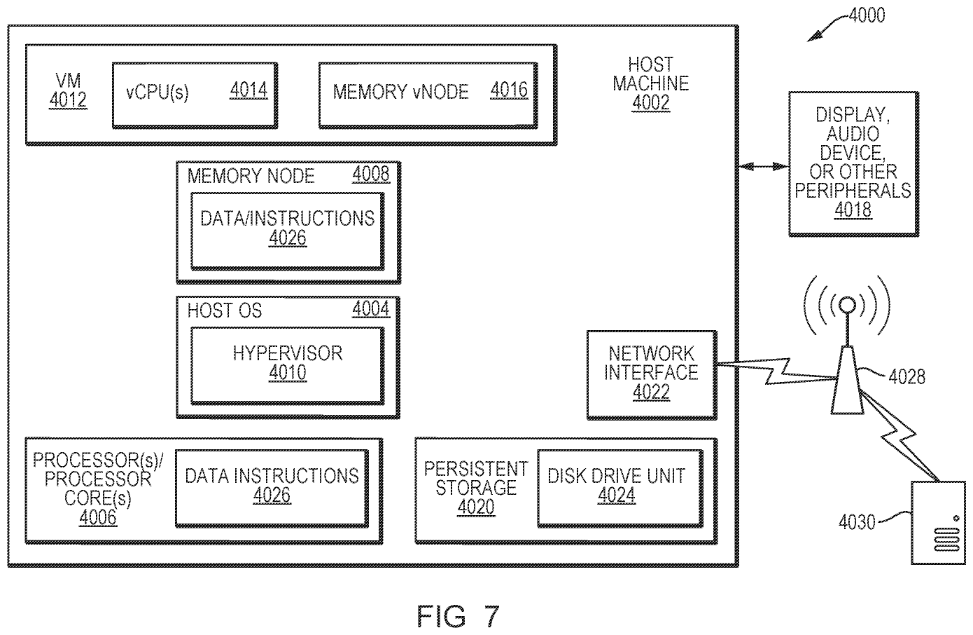

Components of the system 100 such as, for example, the rule generator 101, transaction generator 102, payload parser 103, the rule selector 106, and/or payload validator 104 can be implemented in software, hardware, and/or combinations thereof. Such components may include, or make use of, a number of computer apparatuses, computer systems, or the like. Each of these computer apparatuses, computer systems, or the like are described in greater detail below with respect to the computer apparatus 3000 shown in FIG. 6 and computer system 4000 shown in FIG. 7, which provides a connection between the solution disclosed herein and how such a solution may be implemented within a business entity, such as a payment network, a processing network, a payment processing network, or the like.

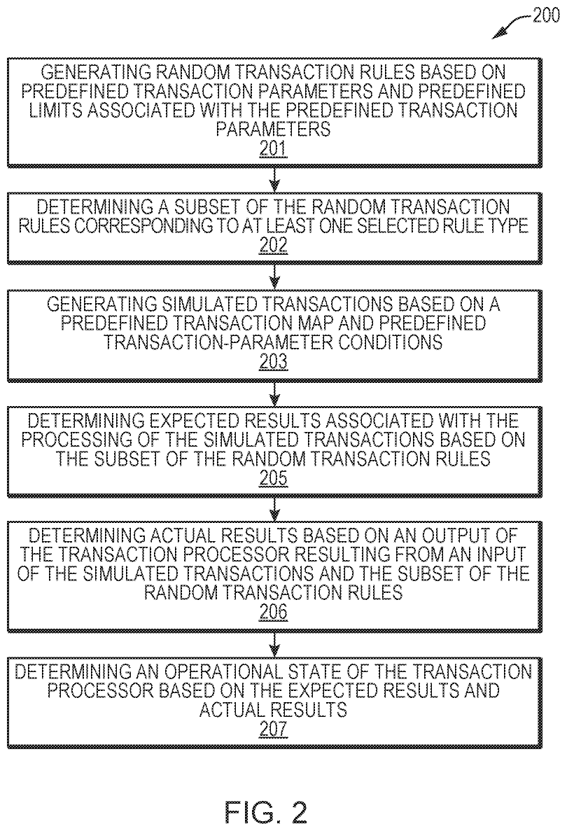

FIG. 2 is a logic flow diagram illustrating a method 200 for testing a transaction processor, according to at least one aspect of the present disclosure. One or more portions of the method 200 can be executed by one or more components of the system 100 to test a transaction processor 110. In the illustrated example, the method 200 includes generating 201 random transaction rules based on predefined transaction parameters and predefined limits associated with the predefined transaction parameters.

The rule generator 101 may receive predefined transaction parameters such as, for example, transaction type, transaction amount, and/or transaction time (e.g., date, time). The transaction parameters may further include payment account parameters, card parameters, merchant parameter, acquirer parameter, issuer parameters, and/or any other parameters relevant to a payment transaction. For example, account parameters may include account number, account type, risk level code, risk flags, and/or account holder information. Additionally, or alternatively, card parameters may include card number, card type, card expiration, and/or card CCV. Additionally, or alternatively, acquirer parameters may include acquirer country code, acquirer region, and/or acquirer bank identification number (BIN). Additionally, or alternatively, merchant parameters may include merchant type, merchant group, merchant city, and/or merchant country.

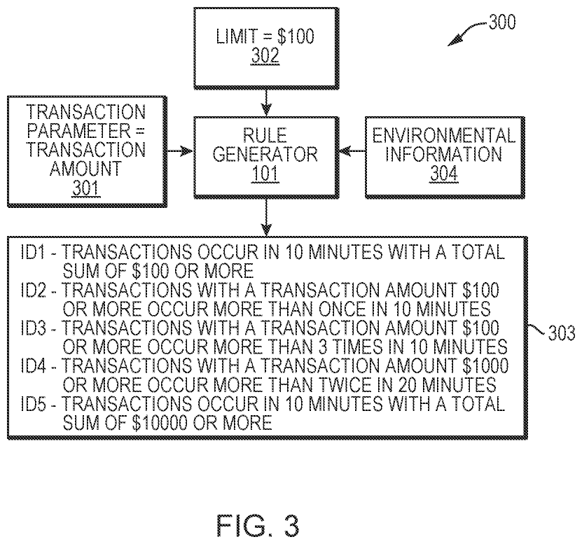

The rule generator 101 may also receive predefined limits associated with the predefined transaction parameters. The predefined limits can, for example, be numerical limits, categorical limits, and/or conditional limits. In one example, as illustrated in FIG. 3, an operation 300 of the rule generator 101 is depicted. The rule generator 101 received a first input 301, indicative of the transaction parameter being a transaction amount, and a second input 302 indicative of the limit being $100. Based on the received inputs 301, 302, the rule generator 101 creates a number of random transaction rules 303 that can be saved by rule storage 105, for example. Each of the randomly created rules 303 is assigned a unique identifier (e.g., ID1-ID5).

The rule generator 101 may receive, as illustrated in FIG. 3, environmental information 304 that can specify how to apply the rules 303. If the environmental information 304 indicates to apply a rule through an application programming interface (API), the rule generator 101 is to initiate an API instance. An API call can be utilized, in a batch operation that creates all rules at once. If, however, the environmental information 304 indicates to apply a rule through a user interface (UI), the rule generator 101 is to initiate a UI instance.

Referring to FIG. 2, the method 200 further includes determining 202 a subset of the random transaction rules corresponding to at least one selected rule type. In some aspects, the rule selector 106 of the system 100 receives an input indicative of at least one selected rule type. The input can be received through a UI 108 in communication with the rule selector 106, for example. In at least one embodiment, a selected rule type can be based on consumer habits, such as frugal consumers, luxury consumers, and impulsive consumers, for example. The rule selector 106 may choose the subset of random transaction rules based on the received input from the UI 108. In some aspects, the rule selector 106 employs a machine learning module in selecting rules based on a selected rule type.

Referring to FIG. 3, given the rules 303, and a selected rule type corresponding to a frugal consumer, for example, the rule selector 106 filters out rules ID1 and ID2, and retains the remaining rules ID3, ID4, and ID5, for example. The selected rules are transmitted to the transaction generator 102. Accordingly, the rule selector 106 effectively functions as a filter passing only rules in accordance with a selected rule type received through the UI 108.

The method 200 further includes generating 203 simulated transactions based on a predefined transaction map 401 and predefined transaction-parameter conditions 402. The method 200 further includes determining 205 expected values/results associated with the processing of the simulated transactions based on the subset of the random transaction rules. As explained in greater detail below, the expected values/results can be derived from the subset of random transaction rules and the simulated transactions that are in accordance with the subset of the random transaction rules.

Furthermore, the method 200 also includes determining 206 actual results based on an output of the transaction processor 110 resulting from an input of the simulated transactions and the subset of the random transaction rules. In addition, the method 200 further includes determining 207 an operational state of the transaction processor based on the expected results and actual results.

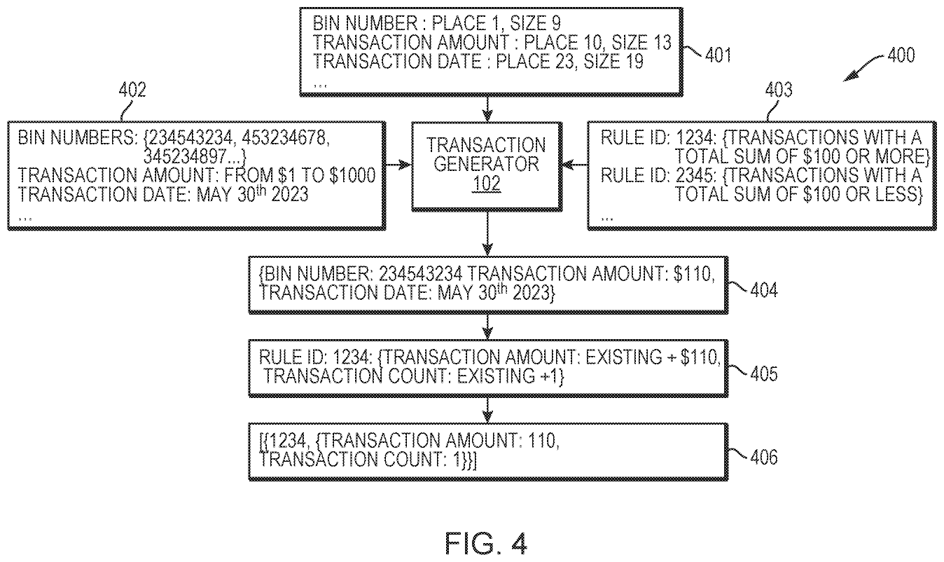

FIG. 4 illustrates an operation 400 of the transaction generator 102 to create simulated transactions based on the predefined transaction map 401 and predefined transaction-parameter conditions 402, and per rules 403 created by the rule generator 101, and received from the rule selector 106, for example. The specific values/results utilized the operations 300, 400 are for illustrative purposes only, and should not be construed as limiting.

As illustrated in FIG. 4, the predefined transaction map 401 indicates which parameters will be in a transaction, their place in the transaction and also their size. Accordingly, the predefined transaction map 401 is to define parameter placements and parameter sizes associated with the simulated transactions. To generate a simulated transaction, the transaction generator 102 queries the predefined transaction map 401 for places and sizes associated with parameters (e.g., BIN number, transaction amount, transaction date) in the simulated transactions. The transaction generator 102 randomly selects places and sizes for the parameters to randomly generate the simulated transactions.

Furthermore, to generate the simulated transactions, a condition file that includes the predefined transaction-parameter conditions 402 is read. The simulated transactions are selected by matching conditions from the predefined transaction-parameter conditions 402 with parameters in the simulated transactions. Accordingly, only simulated transactions that match the predefined transaction-parameter conditions 402 are utilized. The predefined transaction-parameter conditions 402 to be matched are randomly selected by the transaction generator 102.

Furthermore, the transaction generator 102 receives rules 403 transmitted by the rule selector 106, as discussed in connection with FIGS. 1 and 3. The simulated transactions are then matched to the rules 403, and expected values/results 406 are generated for the simulated transactions that are in accordance with any of the rules 403. The expected values/results 406 can be generated in accordance with a formula 405, for example. The formula 405 can be based on rule identifiers of the rules 403 that are matched to the simulated transactions.

In the illustrated example, a simulated transaction 404 comprising a transaction amount of $110 matches a rule (Rule Id (1234) of the rules 403) configured to exclusively select transactions comprising transaction amounts greater than $100. To generate an expected value 406, the formula 404 adds the transaction amount ($110) to the existing/present total transaction amount, and increases the existing/present transaction count of the simulated transactions that match the rule (Rule Id (1234)) by one. The expected value 406 further includes the Rule Id (1234). In the illustrated example, the simulated transaction 404 is a first match to the rule (Rule Id (1234)). Accordingly, the expected value 406 is [{1234, {transaction amount: $110, transaction count: 1}].

Referring to FIG. 1, the transaction processor 110 is coupled to the system 100 for testing. The transaction processor 110 receives the simulated transactions transmitted by the transaction generator 102 and the random transaction rules transmitted by the rule selector 106. The transaction processor 110 then processes the simulated transactions, and outputs a payload that includes fields identifiable through a payload map readable by the payload parser 103.

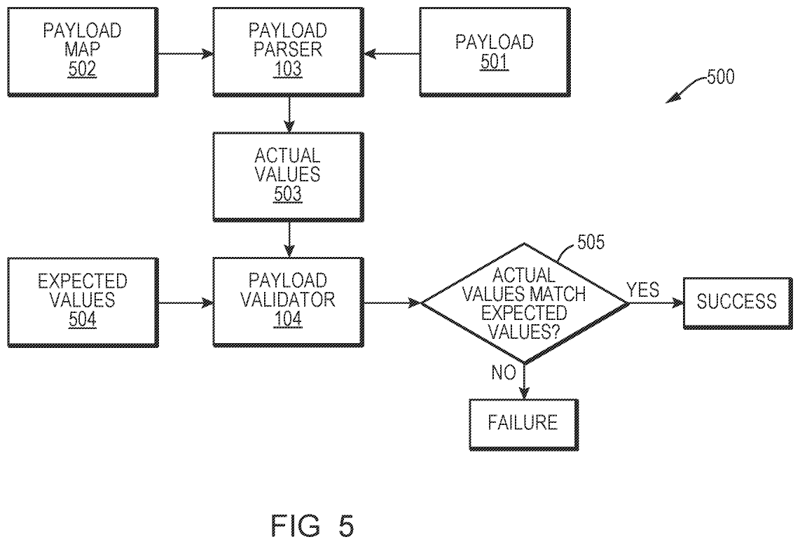

Referring to FIG. 5, an operation 500 of the payload parser 103 comprises receiving a payload 501 from transaction processor 110, querying a payload map 502 to identify relevant fields in the payload, and extracting actual values/results 503 corresponding to the simulated transactions that match to the received rules, based on the relevant fields. For instance, an actual value 503 may include the rule identifier, number of transactions matched to the rule associated with the rule identifier, and the sum of transaction amounts associated with the matched transactions. Accordingly, the payload parser 103, utilizing the payload map 502, may extract rule identifiers, and corresponding transactions counts and transaction amount to determine the actual values/results 503. It is understood that other transactions parameters can be utilized to determine expected and actual values/results.

The payload validator 104 receives the actual values/results 503 determined by the payload parser 103 and the expected values/results 504 determined by the transaction generator 102. The payload validator 104 then compares 505 the actual values/results 503 and the expected values/results 504. A match indicates that the transaction processor 110 has undergone a successful test, while a mismatch indicates a failed test.

The aforementioned systems and methods, as described above with respect to each of FIGS. 1-5, may include, or make use of, a number of computer apparatuses, computer systems, or the like. In other words, in order to utilize the systems and methods disclosed herein, at least one of a computer apparatus, computer system, or the like may be implemented. Each of these computer apparatuses, computer systems, or the like are described in greater detail below with respect to the computer apparatus 3000 shown in FIG. 6 and the example system 4000 shown in FIG. 7, which provide a connection between the solution disclosed herein and how such a solution may be implemented within a business entity, such as a payment network, a processing network, a payment processing network, or the like.

FIG. 6 is a block diagram of a computer apparatus 3000 with data processing subsystems or components, according to at least one aspect of the present disclosure. The subsystems shown in FIG. 6 are interconnected via a system bus 3010. Additional subsystems such as a printer 3018, keyboard 3026, fixed disk 3028 (or other memory comprising computer-readable media), monitor 3022 (which is coupled to a display adapter 3020), and others are shown. Peripherals and input/output (I/O) devices, which couple to an I/O controller 3012 (which can be a processor or other suitable controller), can be connected to the computer system by any number of means known in the art, such as a serial port 3024. For example, the serial port 3024 or external interface 3030 can be used to connect the computer apparatus to a wide area network such as the Internet, a mouse input device, or a scanner. The interconnection via system bus 3010 allows the central processor 3016 to communicate with each subsystem and to control the execution of instructions from system memory 3014 or the fixed disk 3028, as well as the exchange of information between subsystems. The system memory 3014 and/or the fixed disk 3028 may embody a computer-readable medium.

FIG. 7 is a diagrammatic representation of an example system 4000 that includes a host machine 4002 within which a set of instructions to perform any one or more of the methodologies discussed herein may be executed, according to at least one aspect of the present disclosure. In various aspects, the host machine 4002 operates as a stand-alone device or may be connected (e.g., networked) to other machines. In a networked deployment, the host machine 4002 may operate in the capacity of a server or a client machine in a server-client network environment, or as a peer machine in a peer-to-peer (or distributed) network environment. The host machine 4002 may be a computer or computing device, a personal computer (PC); a tablet PC; a set-top box; a personal digital assistant; a cellular telephone; a portable music player (e.g., a portable hard drive audio device, such as an Moving Picture Experts Group Audio Layer 3 (MP3) player); a web appliance; a network router, switch, or bridge; or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example system 4000 includes the host machine 4002, running a host operating system (OS) 4004 on a processor or multiple processor(s)/processor core(s) 4006 (e.g., a central processing unit (CPU), a graphics processing unit, or both), and various memory nodes 4008. The host OS 4004 may include a hypervisor 4010, which is able to control the functions and/or communicate with a virtual machine (VM) 4012 running on machine-readable media. The VM 4012 also may include a virtual CPU or vCPU 4014. The memory nodes 4008 may be linked or pinned to virtual memory nodes or vNodes 4016. When the memory node 4008 is linked or pinned to a corresponding vNode 4016, then data may be mapped directly from the memory nodes 4008 to their corresponding vNodes 4016.

All the various components shown in host machine 4002 may be connected with and to each other or communicate to each other via a bus (not shown) or via other coupling or communication channels or mechanisms. The host machine 4002 may further include a video display, audio device, or other peripherals 4018 (e.g., a liquid crystal display; alpha-numeric input device(s) including, e.g., a keyboard; a cursor control device, e.g., a mouse; a voice recognition or biometric verification unit; an external drive; a signal generation device, e.g., a speaker); a persistent storage device 4020 (also referred to as disk drive unit); and a network interface device 4022. The host machine 4002 may further include a data encryption module (not shown) to encrypt data. The components provided in the host machine 4002 are those typically found in computer systems that may be suitable for use with aspects of the present disclosure and are intended to represent a broad category of such computer components that are known in the art. Thus, the system 4000 can be a server, minicomputer, mainframe computer, or any other computer system. The computer may also include different bus configurations, networked platforms, multi-processor platforms, and the like. Various OSs may be used, including UNIX, LINUX, WINDOWS, QNX ANDROID, IOS, CHROME, TIZEN, and other suitable OSs.

The disk drive unit 4024 also may be a solid-state drive, a hard disk drive, or other drive that includes a computer or machine-readable medium on which is stored one or more sets of instructions and data structures (e.g., data/instructions 4026) embodying or utilizing any one or more of the methodologies or functions described herein. The data/instructions 4026 also may reside, completely or at least partially, within the main memory node 4008 and/or within the processor(s) 4006 during execution thereof by the host machine 4002. The data/instructions 4026 may further be transmitted or received over a network 4028 via the network interface device 4022 utilizing any one of several well-known transfer protocols (e.g., Hyper Text Transfer Protocol (HTTP)).

The processor(s) 4006 and memory nodes 4008 also may comprise machine-readable media. The term “computer-readable medium” or “machine-readable medium” should be taken to include a single medium or multiple medium (e.g., a centralized or distributed database and/or associated caches and servers) that store the one or more sets of instructions. The term “computer-readable medium” shall also be taken to include any medium that is capable of storing, encoding, or carrying a set of instructions for execution by the host machine 4002 and that causes the host machine 4002 to perform any one or more of the methodologies of the present application or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read-only memory (ROM), and the like. The example aspects described herein may be implemented in an operating environment comprising software installed on a computer, in hardware, or in a combination of software and hardware.

Various aspects of the subject matter described herein are set out in the following examples.

Example 1—a transaction-processor tester system for examining a transaction processor, wherein the transaction-processor tester system comprises a rule generator to create random transaction rules based on predefined transaction parameters and predefined limits associated with the predefined transaction parameters, a storage medium to communicate with the rule generator, a rule selector in communication with the storage medium, a transaction generator, a payload parser to receive a payload from the transaction processor, and a payload validator to output a test result for the transaction processor based on the actual values and expected values. The storage medium is to receive and store the random transaction rules. The rule selector is to receive an input indicative of at least one selected rule type, and retrieve a subset of the random transaction rules based on the input. The transaction generator is to generate simulated transactions based on a predefined transaction map and predefined transaction-parameter conditions, check the simulated transactions against the subset of the random transaction rules, and output expected values based on the simulated transactions that are in accordance with the subset of the random transaction rules. The payload comprises an output of the transaction processor from processing the subset of the simulated transactions. The output of the transaction processor comprises actual values associated with processing the subset of the simulated transactions.

Example 2—The system of Example 1, wherein the predefined transaction parameters comprise at least one of a transaction amount, a transaction type, or a transaction date.

Example 3—The system of Examples 1 or 2, wherein the predefined limits comprise at least one of an upper limit, a lower limit, or a range.

Example 4—The system of any one of Examples 1-3, wherein the random transaction rules comprise unique identifiers.

Example 5—The system of any one of Examples 1-4, wherein the predefined transaction map is to define parameter placements and parameter sizes associated with the simulated transactions.

Example 6—The system of any one of Examples 1-5, wherein the test result indicates a failure based on a mismatch between the actual values and expected values.

Example 7—The system of any one of Examples 1-6, wherein the test result indicates a success based on a match between the actual values and expected values.

Example 8—The system of any one of Examples 1-7, wherein the expected values are based on rule identifiers of rules from the subset of random transaction rules that are matched to the simulated transactions.

Example 9—A method for testing a transaction processor, wherein the method comprises generating random transaction rules based on predefined transaction parameters and predefined limits associated with the predefined transaction parameters, determining a subset of the random transaction rules corresponding to at least one selected rule type, generating simulated transactions based on a predefined transaction map and predefined transaction-parameter conditions, determining expected results associated with processing of the simulated transactions based on the subset of the random transaction rules, determining actual results based on an output of the transaction processor resulting from an input of the simulated transactions and the subset of the random transaction rules, and determining an operational state of the transaction processor based on the expected results and actual results.

Example 10—The method of Example 9, wherein the predefined transaction parameters comprise at least one of a transaction amount, a transaction type, or a transaction date.

Example 11—The method of Examples 9 or 10, wherein the predefined limits comprise at least one of an upper limit, a lower limit, or a range.

Example 12—The method of any one of Examples 9-11, wherein the random transaction rules comprise unique identifiers.

Example 13—The method of any one of Examples 9-12, wherein the expected results comprise the unique identifiers.

Example 14—The method of any one of Examples 9-13, wherein the predefined transaction map is to define parameter placements and parameter sizes associated with the simulated transactions.

Example 15—The method of any one of Examples 9-14, wherein the operational state indicates a failed state based on a mismatch between the actual results and expected results.

Example 16—The method of any one of Examples 9-15, wherein the operational state indicates a successful state based on a match between the actual results and expected results.

Example 17—A transaction-processor tester system for examining a transaction processor, wherein the transaction-processor tester system comprises a rule generator to create random transaction rules based on predefined transaction parameters and predefined limits associated with the predefined transaction parameters, a rule selector, a transaction generator, a payload parser, and a payload validator to output a test result for the transaction processor based on the actual results and expected results. The rule selector is to receive an input indicative of at least one selected rule type, and retrieve a subset of the random transaction rules based on the input. The transaction generator is to generate simulated transactions based on a predefined transaction map and predefined transaction-parameter conditions, and determine expected results associated with processing of the simulated transactions based on the subset of the random transaction rules. The payload parser is to receive a payload from the transaction processor, and determine actual results based on the output of the transaction processor. The payload includes an output of the transaction processor from processing the subset of the simulated transactions.

Example 18—The system of Example 17, herein the predefined transaction parameters comprise at least one of a transaction amount, a transaction type, or a transaction date.

Example 19—The system of Examples 17 or 18, wherein the predefined limits comprise at least one of an upper limit, a lower limit, or a range.

Example 20—The system of any one of Examples 17-19, wherein the random transaction rules comprise unique identifiers.

One skilled in the art will recognize that Internet service may be configured to provide Internet access to one or more computing devices that are coupled to the Internet service and that the computing devices may include one or more processors, buses, memory devices, display devices, I/O devices, and the like. Furthermore, those skilled in the art may appreciate that the Internet service may be coupled to one or more databases, repositories, servers, and the like, which may be utilized to implement any of the various aspects of the disclosure as described herein.

The computer program instructions also may be loaded onto a computer, a server, other programmable data processing apparatus, or other devices to cause a series of operational steps to be performed on the computer, other programmable apparatus, or other devices to produce a computer-implemented process such that the instructions that execute on the computer or other programmable apparatus provide processes for implementing the functions/acts specified in the flowchart and/or block diagram block or blocks.

Suitable networks may include or interface with any one or more of, for instance, a local intranet; a personal area network (PAN); a local area network (LAN); a wide area network (WAN); a metropolitan area network (MAN); a virtual private network (VPN); a storage area network (SAN); a frame relay connection; an advanced intelligent network (AIN) connection; a synchronous optical network (SONET) connection; a digital T1, T3, E1, or E3 line; a digital data service (DDS) connection; a digital subscriber line (DSL) connection; an Ethernet connection; an integrated services digital network (ISDN) line; a dial-up port, such as a V.90, V.34, or V.34bis analog modem connection; a cable modem; an Asynchronous Transfer Mode (ATM) connection; or an Fiber Distributed Data Interface (FDDI) or Copper Distributed Data Interface (CDDI) connection. Furthermore, communications may also include links to any of a variety of wireless networks, including Wireless Application Protocol (WAP), General Packet Radio Service (GPRS), Global System for Mobile Communication (GSM), Code Division Multiple Access (CDMA) or Time Division Multiple Access (TDMA), cellular phone networks, global positioning system (GPS), cellular digital packet data (CDPD), Research in Motion, Limited (RIM) duplex paging network, Bluetooth radio, or an Institute of Electrical and Electronics Engineers (IEEE) 802.11-based radio frequency (RF) network. The network 4028 can further include or interface with any one or more of an RS-232 serial connection, an IEEE-1394 (Firewire) connection, a Fiber Channel connection, an IrDA (infrared (IR)) port, a Small Computer Systems Interface (SCSI) connection, a Universal Serial Bus (USB) connection or other wired or wireless, digital, or analog interface or connection, mesh, or Digi® networking.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the host machine 4002, with each server 4030 (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media, and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one aspect of a bus. Transmission media can also take the form of acoustic or light waves, such as those generated during RF and IR data communications. Common forms of computer-readable media include, for example, a flexible disk, a hard disk, magnetic tape, any other magnetic medium, a compact disc ROM (CD-ROM) disk, digital video disc, any other optical medium, any other physical medium with patterns of marks or holes, a RAM, a programmable ROM, an erasable programmable ROM (EPROM), an electrically erasable programmable ROM (EEPROM), a FLASH EPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object-oriented programming language such as Java, Smalltalk, C++, or the like and conventional procedural programming languages, such as the “C” programming language, Go, Python, or other programming languages, including assembly languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a LAN or a WAN, or the connection may be made to an external computer (for example, through the Internet using an Internet service provider).

The foregoing detailed description has set forth various forms of the systems and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, and/or examples can be implemented, individually and/or collectively, by a wide range of hardware, software, firmware, or virtually any combination thereof. Those skilled in the art will recognize that some aspects of the forms disclosed herein, in whole or in part, can be equivalently implemented in integrated circuits as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skilled in the art in light of this disclosure. In addition, those skilled in the art will appreciate that the mechanisms of the subject matter described herein are capable of being distributed as one or more program products in a variety of forms, and an illustrative form of the subject matter described herein applies regardless of the particular type of signal-bearing medium used to actually carry out the distribution.

Instructions used to program logic to perform various disclosed aspects can be stored within a memory in the system, such as dynamic RAM, cache, flash memory, or other storage. Furthermore, the instructions can be distributed via a network or by way of other computer-readable media. Thus a machine-readable medium may include any mechanism for storing or transmitting information in a form readable by a machine (e.g., a computer), including, but not limited to, floppy diskettes, optical disks, CD-ROMs, magneto-optical disks, ROM, RAM, EPROM, EEPROM, magnetic or optical cards, flash memory, or a tangible, machine-readable storage used in the transmission of information over the Internet via electrical, optical, acoustical, or other forms of propagated signals (e.g., carrier waves, IR signals, digital signals). Accordingly, the non-transitory computer-readable medium includes any type of tangible machine-readable medium suitable for storing or transmitting electronic instructions or information in a form readable by a machine (e.g., a computer).

Any of the software components or functions described in this application may be implemented as software code to be executed by a processor using any suitable computer language, such as, for example, Python, Java, C++, or Perl, using, for example, conventional or object-oriented techniques. The software code may be stored as a series of instructions or commands on a computer-readable medium, such as RAM, ROM, a magnetic medium such as a hard drive or a floppy disk, or an optical medium such as a CD-ROM. Any such computer-readable medium may reside on or within a single computational apparatus and may be present on or within different computational apparatuses within a system or network.

As used in any aspect herein, the term “logic” may refer to an app, software, firmware, and/or circuitry configured to perform any of the aforementioned operations. Software may be embodied as a software package, code, instructions, instruction sets, and/or data recorded on a non-transitory computer-readable storage medium. Firmware may be embodied as code, instructions, instruction sets, and/or data that are hard-coded (e.g., non-volatile) in memory devices.

As used in any aspect herein, the terms “component,” “system,” “module,” and the like can refer to a computer-related entity, either hardware, a combination of hardware and software, software, or software in execution.

As used in any aspect herein, an “algorithm” refers to a self-consistent sequence of steps leading to a desired result, where a “step” refers to a manipulation of physical quantities and/or logic states that may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

A network may include a packet-switched network. The communication devices may be capable of communicating with each other using a selected packet-switched network communications protocol. One example communications protocol may include an Ethernet communications protocol, which may be capable of permitting communication using a Transmission Control Protocol/Internet Protocol. The Ethernet protocol may comply or be compatible with the Ethernet standard published by the IEEE titled “IEEE 802.3 Standard,” published in December 2008 and/or later versions of this standard. Alternatively or additionally, the communication devices may be capable of communicating with each other using an X.25 communications protocol. The X.25 communications protocol may comply or be compatible with a standard promulgated by the International Telecommunication Union-Telecommunication Standardization Sector. Alternatively or additionally, the communication devices may be capable of communicating with each other using a frame relay communications protocol. The frame relay communications protocol may comply or be compatible with a standard promulgated by Consultative Committee for International Telegraph and Telephone and/or the American National Standards Institute. Alternatively or additionally, the transceivers may be capable of communicating with each other using the ATM communications protocol. The ATM communications protocol may comply or be compatible with an ATM standard published by the ATM Forum titled “ATM-MPLS Network Interworking 2.0,” published August 2001, and/or later versions of this standard. Of course, different and/or after-developed connection-oriented network communication protocols are equally contemplated herein.

Unless specifically stated otherwise as apparent from the foregoing disclosure, it is appreciated that, throughout the present disclosure, discussions using terms such as “processing,” “computing,” “calculating,” “determining,” “displaying,” or the like refer to the action and processes of a computer system, or similar electronic computing device, that manipulates and transforms data represented as physical (electronic) quantities within the computer system's registers and memories into other data similarly represented as physical quantities within the computer system memories, registers, or other such information storage, transmission, or display devices.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components, inactive-state components, and/or standby-state components, unless context requires otherwise.

Those skilled in the art will recognize that, in general, terms used herein, and especially in the appended claims (e.g., bodies of the appended claims) are generally intended as “open” terms (e.g., the term “including” should be interpreted as “including, but not limited to”; the term “having” should be interpreted as “having at least”; the term “includes” should be interpreted as “includes, but is not limited to”). It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general, such a construction is intended in the sense one having skill in the art would understand the convention (e.g., “a system having at least one of A, B, and C” would include, but not be limited to, systems that have A alone, B alone, C alone, A and B together, A and C together, B and C together, and/or A, B, and C together). In those instances where a convention analogous to “at least one of A, B, or C, etc.” is used, in general, such a construction is intended in the sense one having skill in the art would understand the convention (e.g., “a system having at least one of A, B, or C” would include, but not be limited to, systems that have A alone, B alone, C alone, A and B together, A and C together, B and C together, and/or A, B, and C together). It will be further understood by those skilled in the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A,” “B,” or “A and B.”

With respect to the appended claims, those skilled in the art will appreciate that recited operations therein may generally be performed in any order. Also, although various operational flow diagrams are presented in sequence(s), it should be understood that the various operations may be performed in other orders than those that are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures, or characteristics may be combined in any suitable manner in one or more aspects.

As used herein, the singular form of “a,” “an,” and “the” include the plural references unless the context clearly dictates otherwise.

Any patent application, patent, non-patent publication, or other disclosure material referred to in this specification and/or listed in any Application Data Sheet is incorporated by reference herein, to the extent that the incorporated material is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein, will only be incorporated to the extent that no conflict arises between that incorporated material and the existing disclosure material. None is admitted to be prior art.

In summary, numerous benefits have been described that result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms with various modifications as are suited to the particular use contemplated. It is intended that the claims submitted herewith define the overall scope.

What is claimed is:

1. A transaction-processor tester system for examining a transaction processor, the transaction-processor tester system comprising:
a rule generator to create random transaction rules based on predefined transaction parameters and predefined limits associated with the predefined transaction parameters;
a storage medium to communicate with the rule generator, wherein the storage medium is to receive and store the random transaction rules;
a rule selector in communication with the storage medium, wherein the rule selector is to:
receive an input indicative of at least one selected rule type; and
retrieve a subset of the random transaction rules based on the input;
a transaction generator to:
generate simulated transactions based on a predefined transaction map and predefined transaction-parameter conditions;
check the simulated transactions against the subset of the random transaction rules; and
output expected values based on the simulated transactions that are in accordance with the subset of the random transaction rules;
a payload parser to receive a payload from the transaction processor, the payload comprising an output of the transaction processor from processing the subset of the simulated transactions, the output of the transaction processor comprises actual values associated with processing the subset of the simulated transactions; and
a payload validator to output a test result for the transaction processor based on the actual values and expected values.

2. The transaction-processor tester system of claim 1, wherein the predefined transaction parameters comprise at least one of a transaction amount, a transaction type, or a transaction date.

3. The transaction-processor tester system of claim 2, wherein the predefined limits comprise at least one of an upper limit, a lower limit, or a range.

4. The transaction-processor tester system of claim 1, wherein the random transaction rules comprise unique identifiers.

5. The transaction-processor tester system of claim 1, wherein the predefined transaction map is to define parameter placements and parameter sizes associated with the simulated transactions.

6. The transaction-processor tester system of claim 1, wherein the test result indicates a failure based on a mismatch between the actual values and expected values.

7. The transaction-processor tester system of claim 1, wherein the test result indicates a success based on a match between the actual values and expected values.

8. The transaction-processor tester system of claim 1, wherein the expected values are based on rule identifiers of rules from the subset of random transaction rules that are matched to the simulated transactions.

9. A method for testing a transaction processor, the method comprising:
generating random transaction rules based on predefined transaction parameters and predefined limits associated with the predefined transaction parameters;
determining a subset of the random transaction rules corresponding to at least one selected rule type;
generating simulated transactions based on a predefined transaction map and predefined transaction-parameter conditions;
determining expected results associated with processing of the simulated transactions based on the subset of the random transaction rules;
determining actual results based on an output of the transaction processor resulting from an input of the simulated transactions and the subset of the random transaction rules; and
determining an operational state of the transaction processor based on the expected results and actual results.

10. The method of claim 9, wherein the predefined transaction parameters comprise at least one of a transaction amount, a transaction type, or a transaction date.

11. The method of claim 10, wherein the predefined limits comprise at least one of an upper limit, a lower limit, or a range.

12. The method of claim 9, wherein the random transaction rules comprise unique identifiers.

13. The method of claim 12, wherein the expected results comprise the unique identifiers.

14. The method of claim 9, wherein the predefined transaction map is to define parameter placements and parameter sizes associated with the simulated transactions.

15. The method of claim 9, wherein the operational state indicates a failed state based on a mismatch between the actual results and expected results.

16. The method of claim 9, wherein the operational state indicates a successful state based on a match between the actual results and expected results.

17. A transaction-processor tester system for examining a transaction processor, the transaction-processor tester system comprising:
a rule generator to create random transaction rules based on predefined transaction parameters and predefined limits associated with the predefined transaction parameters;
a rule selector to:
receive an input indicative of at least one selected rule type; and
retrieve a subset of the random transaction rules based on the input;
a transaction generator to:
generate simulated transactions based on a predefined transaction map and predefined transaction-parameter conditions;
determining expected results associated with processing of the simulated transactions based on the subset of the random transaction rules;
a payload parser to:
receive a payload from the transaction processor, the payload comprising an output of the transaction processor from processing the subset of the simulated transactions;
determine actual results based on the output of the transaction processor; and
a payload validator to output a test result for the transaction processor based on the actual results and expected results.

18. The transaction-processor tester system of claim 17, wherein the predefined transaction parameters comprise at least one of a transaction amount, a transaction type, or a transaction date.

19. The transaction-processor tester system of claim 18, wherein the predefined limits comprise at least one of an upper limit, a lower limit, or a range.

20. The transaction-processor tester system of claim 17, wherein the random transaction rules comprise unique identifiers.
